(19) United States
(12) Patent Application Publication
(10) Pub. No.: US 2012/0274607 A1
(43) Pub. Date: Nov. 1, 2012

(54) OPTICAL FINGER NAVIGATION DEVICE

(75) Inventors: Khoon Guan Tee, Penang (MY); Hun Kwang Lee, Penang (MY); Chee Foo Lum, Penang (MY)

(73) Assignee: Avago Technologies ECBU IP (Singapore) Pte. Ltd., Singapore (SG)

(21) Appl. No.: 13/098,080

(22) Filed: Apr. 29, 2011

(51) Int. Cl. G06F 3/042

(52) U.S. Cl. 345/175

(57) ABSTRACT

An optical finger navigation (OFN) device for use devices such as handheld portable devices is presented. The OFN device may include a lead frame, a light sensor, a clear mold compound encapsulating the light sensor and the lead frame so as to form the package. The mold compound may include a light guide system disposed thereon to direct light towards the light sensor. The OFN package may further include a light opaque material disposed on the mold compound to shield the light sensor against stray lights.

### BACKGROUND

Optical navigation sensors are conventionally used for surface navigation input devices, such as an optical mouse for computers. Navigation, in this context, refers to providing an input function to a computer for manipulating the operation of the computer system. In general, an optical input device tracks the relative movement between a navigation surface, such as a mouse pad or a work surface, and a sensor within the optical input device. Light is illuminated towards the navigation surface or a target object by a light source such as a light emitting diode. Images of the illuminated navigation surface are captured by the sensor, subsequently processed and further translated as a cursor movement on the input device.

More recently, optical finger navigation devices have been widely used in many small handheld devices, such as a mobile handset, to provide navigation input function by simply moving a finger on a finger interface surface of such a portable device. The general operational concept of an optical finger navigation device is similar to a conventional optical mouse. One difference is that the sensor used for finger navigation is generally positioning face-up rather than downward. In contrast to a conventional optical mouse system, an optical finger navigation device uses a light source to illuminate a user's finger rather than a work surface. A navigation signal is then generated based on the comparison of sequential images captured of the user's finger.

Optical navigation systems can be effectively used in many small handheld devices such as a mobile handset or a game console controller. However, a typical optical navigation package is known to include a light sensor being encapsulated in a mold compound and a lens, all of which increase the height and the size of the package. As the package size becomes smaller, the manufacturing process inevitably becomes more complex and expensive. Therefore, a thin and small profile optical navigation device that can be manufactured easily and more inexpensively is desirable. Furthermore, it is also desirable to provide optical navigation devices that have the versatility of being used in various handheld devices. Additional advantage would be realized by implementing optical navigation solutions that require fewer component parts and reduced assembly and component cost.

### BRIEF DESCRIPTION OF THE DRAWINGS

The disclosed invention will be described with reference to the accompanying drawings, which show different aspects of the various embodiments of the invention wherein:

FIG. 1 is a perspective view of a handheld device with an optical finger navigation device;

FIG. 2 is a partially exploded view of one embodiment of an optical finger navigation package;

FIG. 3 is a cut-away view of an optical finger navigation package;

FIG. 4 is a block diagram of one embodiment of a handheld device having an ultra-thin optical finger navigation package being incorporated therein;

FIG. 5 is a perspective exploded view of an optical finger navigation package;

FIG. 6 is a perspective view of one embodiment of a lead frame;

FIG. 7 is a perspective view of a lead frame with leads;

FIG. 8 is a cut away view of one embodiment of an optical finger navigation package with a light opaque material; and

FIG. 9 is a flowchart illustrating a method of manufacturing of an ultra-thin optical finger navigation package.

### DETAILED DESCRIPTION

Optical finger navigation (hereinafter OFN) devices provide an input interface for electronic devices. OFN are particularly useful in small handheld electronic devices, such as mobile phones, remote controls, game console controllers, portable music players, or other devices that normally benefit from navigation functionality that can be operated by a user's finger.

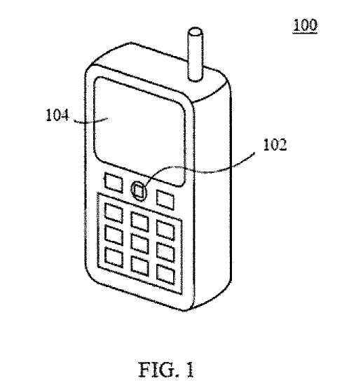

FIG. 1 illustrates an example of a mobile phone 100, which includes an OFN device 102. The OFN device 102 allows the user to manipulate the functions of the mobile phone 100 with a finger (such as finger 302 shown in FIG. 3). For example, the mobile phone 100 may have a graphical user interface (GUI) on the display 104 and an OFN device 102 may be incorporated therein to provide a navigation operation of the GUI. FIG. 1 specifically illustrates a handheld mobile phone, however, the OFN device 102 may be integrated in other electronic devices, such as those listed above, in order to provide various navigation operations.

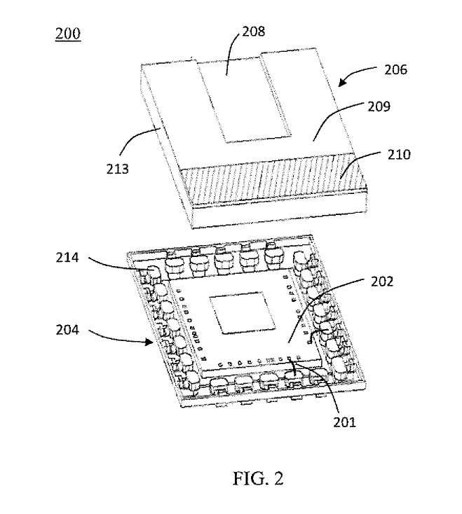

FIG. 2 to FIG. 9 show various embodiments of the invention. However, it is to be understood that other embodiments may be modified without departing from the scope of the present invention. For example, the OFN package may be modified for use in free-space navigation applications such as free-space presentation pointer. In this case, a wide angle lens may be included to enable the OFN package to capture images from the open space as the pointer moves. The OFN package may cross correlate the surface features of the images captured and subsequently translate the pointer movement to a corresponding cursor movement

FIG. 2 is a partially exploded view of one embodiment of an optical finger navigation package 200. The OFN package 200 includes a light sensor 202, a lead frame 204 and a mold compound 206. The mold compound 206 encapsulates the light sensor 202 and the lead frame 204 together so as to form the package 200. The OFN package 200 also includes a light guide system 208 disposed on the mold compound 206 for directing light towards the light sensor 202. It should be noted that the OFN package 200 may come in various configurations, the featured components can be positioned in a number of different orientations; the directional terminology is used for purposes of illustration and is in no way limiting.

In the embodiment illustrated by FIG. 2, the OFN package 200 includes a light sensor 202, a lead frame 204, a mold compound 206 having a front surface 209, a back surface 211 (such as back surface shown in FIG. 3) and at least one side surface 213, a light guide system 208 disposed on the front surface 209 of the mold compound 206 and a light opaque material 210 covering at least a portion of the front surface 209. The light opaque material 210 is configured to prevent stray light from entering the light sensor 202 and interfere with navigation operation of the device.

The light sensor 202 is operable to receive light entering through the front surface 209, for example, light reflected from a finger (such as finger 302 shown in FIG. 3). The light sensor 202 is configured to capture multiple images of the finger and subsequently cross correlates the surface features of these images to determine the relative motion between the finger 302 and the handheld device in terms of movement vectors in the directional delta X and delta Y. The light sensor 202 is configured to process and further translate the determined motion data to a corresponding cursor movement on the handheld device. In one embodiment, the sensor 202 may be any type of optical sensor known in the art, such as a photo-detector, a Charge Couple Device (CCD), a Complementary Metal Oxide Semiconductor (CMOS) sensor, or other similar sensor type devices. In one embodiment, the light sensor 202 may be electrically connected to the top surface 214 of the lead frame 204 by one or more of wire bond 201.

FIG. 3 is a cut away view of an optical finger navigation package 200. The OFN package 200 includes a light sensor 202, a lead frame 204 and a mold compound 206 encapsulating the light sensor 202 and the lead frame 204 together so as to form the package 200. The OFN package 200 includes a transparent or a clear mold compound 206 for encapsulating the light sensor 202 and the lead frame 204 together. The molding may be accomplished by any suitable molding process. For example, the mold compound 206 may be molded over the light sensor 202 and the lead frame 204 by a conventional injection molding process. The mold compound 206 may be any suitable molding material. For example, the transparent mold compound 206 may be manufactured by Nitta Denko having a part number NT8506. However, other transparent compounds such as transparent epoxy resin may also be used.

In one embodiment, the second surface 205 of the light sensor 202 is exposed on the back surface 211 of the mold compound 206. A light opaque material 410 is disposed on the second surface 205 to prevent stray light from entering through the bottom of the light sensor 202. As shown in FIG. 3, the light sensor 202 is encapsulated by the mold compound 206 and configured to “float” therein. The light sensor 202 may be disposed within the mold compound 206 in a manner such that the entire light sensor 202 is covered by the mold compound 206 except for its second surface 205. Thereby making the light sensor 202 appear to be “floated” inside the mold compound 206. The exposure of the second surface 205 of the light sensor 202 on the back surface 211 may also facilitate excellent thermal performance. Therefore, heat generated during operation may be dissipated through the second surface 205 more efficiently. In addition, the exposure of the second surface 205 may also render the OFN package 200 thinner and enable it to be versatile when subjected to subsequent assembly processes.

The light sensor 202 is electrically connected to the top surface 214 of the lead frame 204 by one or more of wire bond 201. In one embodiment, the top surface 214 of the lead frame 204 may include a wire bond pad (not shown) for wire bonding. The bottom surface 216 of the lead frame 204 may include a contact pad to facilitate further assembly processes. In another embodiment, the bottom surface 216 may be exposed on the bottom of the OFN package 200 to allow for further assembly. The exposed bottom surface 216 may also make the OFN package 200 versatile for further integration to any handheld device by enabling it to be assembled thereon by using a chip surface mounting machine which is well known in the art.

As shown in FIG. 3, the OFN package 200 includes a light guide system 208 disposed on the mold compound 206 for directing light towards the light sensor 202. In one embodiment, the light guide system 208 is variously embodied and may include a recessed region 220 or a mirror-finish surface formed on the front surface 209 of the mold compound 206. The light guide system 208 may be formed on the front surface 209 adjacent to the first surface 203 of the light sensor 202. The position of the light guide system 208 may also be substantially aligned with the first surface 203 in order to allow the light to be effectively communicated towards the light sensor 202. In certain embodiments, the light guide system 208 may also include a treated surface which may be formed in a variety different ways on the front surface 209. For example, a fine-grade lens polisher may be utilized to treat or polish the front surface 209 to form a light guide system 208 thereon.

In an alternative embodiment, the light guide system 208 may also be formed simultaneously under the same molding process when the light sensor 202 and the lead frame 204 are being molded with mold compound 206. Additionally, the light guide system 208 may be further polished to produce a mirror-finish surface in order to improve its performance. Alternatively, a mold compound 206 with a flat or plain front surface 209 may be molded first, and a light guide system 208 may be formed subsequently. In one embodiment, the integration of the light guide system 208 on the front surface 209 of the mold compound 206 may avoid the need of an extra lens system to direct light toward the light sensor 202; therefore, an ultra-thin OFN package 200 may be made possible.

In one embodiment, the illustrated OFN package 200 is an ultra-thin package. The overall thickness of the OFN package 200 may be limited by the thickness of the mold compound 206. Similarly, the thickness may also be limited by the moldability of the mold compound 206 to form the package 200. For example, the OFN package 200 may have a z-height which is slightly thicker than the lead frame 204, thus making it ultra-thin. The OFN package 200 may have a package z-height of 0.325 mm, whereby the lead frame 204 may have a thickness of 0.2 mm, or less.

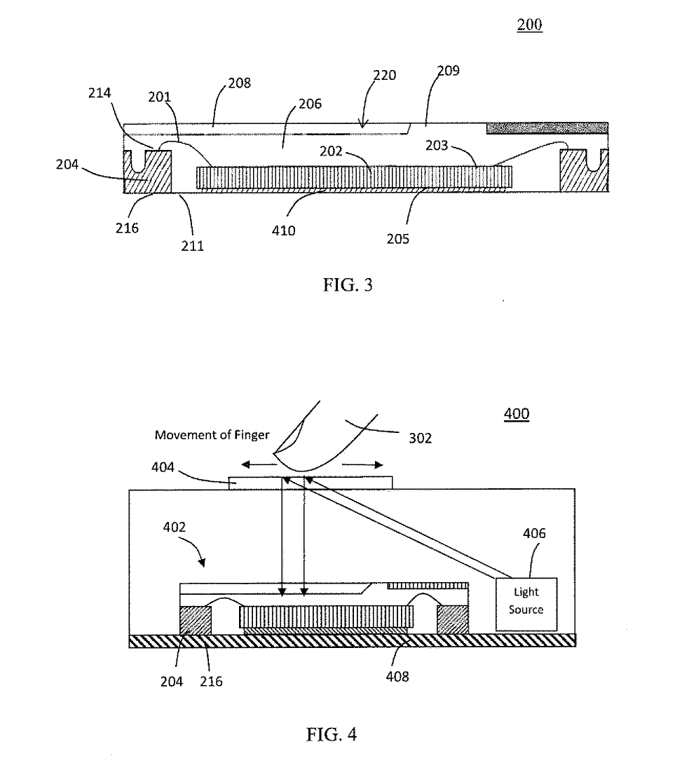

As the OFN package may be made ultra-thin; therefore it can be suitably employed in a variety of small and thin handheld devices. FIG. 4 is a block diagram of one embodiment of a handheld device 400 having an ultra-thin optical finger navigation package being incorporated therein for providing a finger navigation operation. For example, the package 402 may be assembled onto a PCB 408 of the handheld device 400 whereby the exposed bottom surface 216 of the lead frame 204 is in direct contact with the PCB 408. The package 402 may be assembled by using a chip surface mounting machine or a soldering machine which is well known in the art. Specifically, the chip surface mounting technology has been widely adopted in many automatic IC package assembly lines and is particularly known to be an efficient and low cost process. However, other assembly method, such as a conventional solder flow process may also be employed. The handheld device 400 includes a navigation surface 404 or a designated touch region for a user to place an object (e.g., finger 302) for operating the navigation function. Apart from finger 302, other objects such as a stylus, pen, or other similar objects could be used for navigating the handheld device 400. In one embodiment, the handheld device 400 includes a light source 406 configured to emit light towards the navigation surface 404. The light source 406 may be placed adjacent to the package 402 without increasing the overall z-height of the handheld device 400. The light source 406 may be a coherent light source or a non-coherent light source. In addition, the light source 406 may be a visible LED or a non-visible light (e.g. IR LED). The selection of the light source 406 is normally determined by the application. However, it should be noted that light source 406 may be more than one source of light, as may be required by certain applications.

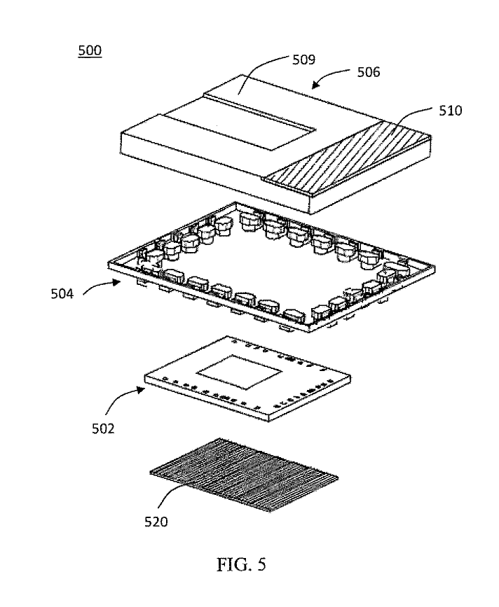

FIG. 5 is a perspective exploded view illustrating an optical finger navigation package. The OFN package 500 includes light sensor 502 configured to electrically connected to a lead frame 504, a first light opaque material 510 and a second light opaque material 520. In one embodiment, the first light opaque material 510 is configured to cover at least a portion of the top surface 509 to prevent any unwanted stray light from entering the light sensor 502. In another embodiment, the OFN package 500 may further include a second light opaque material 520 disposed on the second surface 205 (such as back second surface shown in FIG. 3) of the light sensor 502. The second light opaque material 520 is configured to further prevent stray light from entering through the bottom of the mold compound.

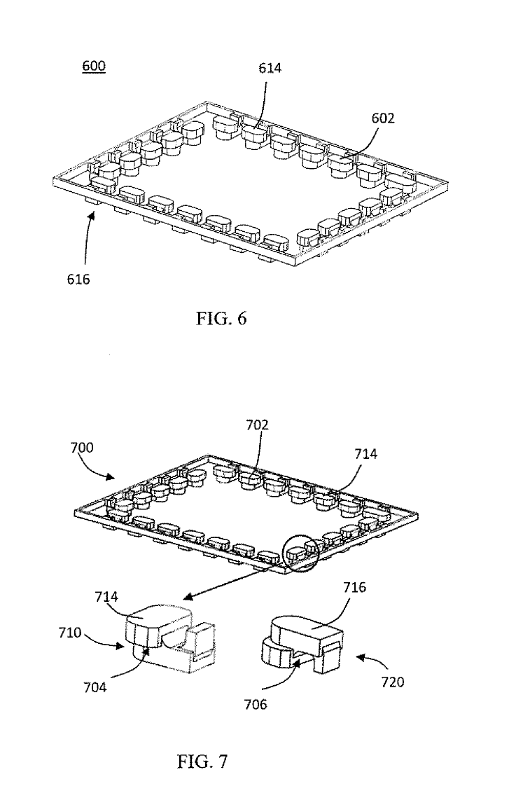

FIG. 6 is a perspective view of one embodiment of a lead frame 600. The illustrated lead frame 600 includes a top surface 614 and a bottom surface 616 opposite to the top surface 614. In one embodiment, the lead frame 600 is etched and has no die-attach pad. The lead frame 600 also includes a plurality of terminals or leads 602. The lead frame 600 may be formed by a conventional stamping process. In one embodiment, the lead frame 600 is further etched in order to enhance to the integrity of the package. The lead frame 600 may be a quad flat pack no-lead (QFN) lead frame, such as a copper QFN lead frame. The top surface 614 of each lead 602 may include a wire bond pad for wire bonding. The bottom surface 616 may include a flat surface to facilitate as a contact pad for further assembly process.

FIG. 7 is a perspective view illustrating a lead frame 700 with leads 702. The illustrated lead frame 700 includes a top surface 714 and a bottom surface 716 opposite to the top surface 714. In one embodiment, the lead frame 700 includes a plurality of terminals or leads 702. In FIG. 7, the lead 710 is a zoom-in top perspective view of one of the lead 702, whereas the lead 720 represent a bottom perspective view of the same lead 702. In one embodiment, the lead frame includes one or more etched regions for providing a locking feature to improve the interlocking strength between the mold compound and the lead frame 700. During the molding process, portion of the mold compound 506 (such as mold compound shown in FIG. 5) may be formed around the etched regions of the lead frame 700, for example, the bottom regions 704 and 706 of both leads 710 and 720, and lock the mold compound against the lead frame 700. Such a locking feature may reduce the possibility of the mold compound 506 from being delaminated from the lead frame when the package is being subjected to stress.

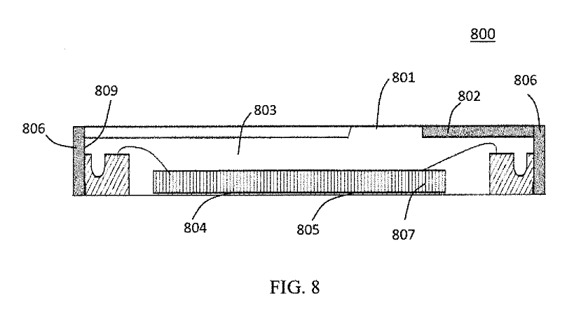

FIG. 8 is a cut away view of one embodiment of an optical finger navigation package 800 with a light opaque material. In one embodiment, the OFN package 800 includes a first light opaque material 802 disposed on the front surface 801 of the clear mold compound 803, a second light opaque material 804 disposed on the second surface 805 of the light sensor 807 and a third light opaque material 806 covering the side surfaces 809 of the clear mold compound 803. The light opaque material 802 may cover only a portion of the front surface 801. If there is a light source (not shown) above or nearby the OFN package 800, such as similar to the previously described FIG. 3, the light opaque material 802 may prevent the stray light entering the light sensor 807 through the front surface 801. In another embodiment, the OFN package 800 includes a second light opaque material 804 disposed on the second surface 805 of the light sensor 807 to prevent stray light from entering through the bottom of the OFN package 800. In another embodiment, the OFN package 800 includes a third light opaque material 806 covering the side surfaces 809 of the clear mold compound 803 to prevent stray light from entering through the sides. However, as a matter of design choice, any of the above mentioned light opaque material may be selectively applied an area, if necessary, for protection against stray light. For example, the light opaque material may be applied only to areas on the package in accordance to the customer specification.

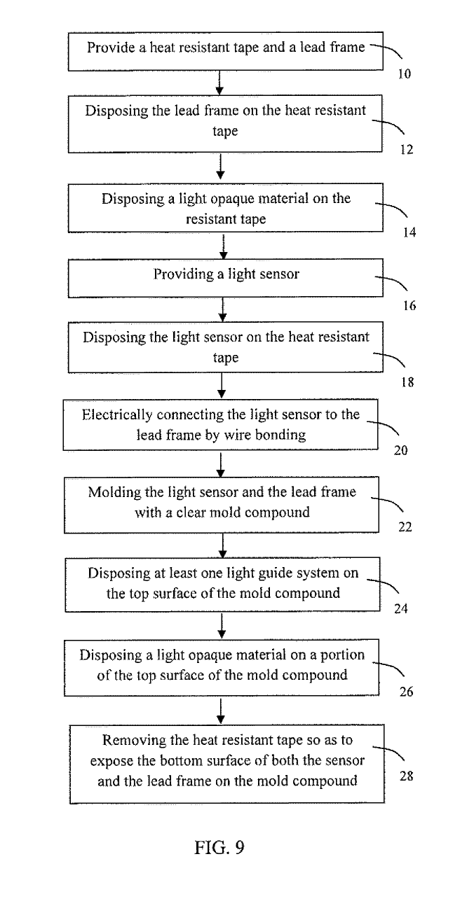

FIG. 9 is a flowchart illustrating a method of manufacturing of an ultra thin optical finger navigation package. Beginning at step 10, a heat resistant tape and a lead frame are provided. The heat resistant tape is a “Kapton” tape which is also known as high temperature tape suitable for package assembly process. In another embodiment, the lead frame has no die-attached pad and may include of a top surface and a bottom surface. At step 12, the lead frame is disposed on the heat resistant tape. At step 14, a light opaque material is disposed on at least a portion of the resistant tape. At step 16, a light sensor is provided, wherein the light sensor has a top and a bottom surface. At step 18, the light sensor is disposed on the heat resistant tape such that the bottom surface of the light sensor is covered by the light opaque material. At step 20, the light sensor is electrically connected to the lead frame by wire bonding. At step 22, a clear mold compound is molded over the light sensor and the lead frame, wherein the bottom surface of both the light sensor and the lead frame are exposed. At step 24, a light guide is disposed on the top surface of the mold compound, wherein the light guide system is disposed adjacent to and substantially aligned with the top surface of the light sensor. The light guide system is a mirror-finish surface and is configured to direct light toward the light sensor. At step 26, a light opaque material is disposed on the top surface of the mold compound, wherein the light opaque material is configured to shield the light sensor from stray light. At step 28, the heat resistant tape is removed so as to expose the bottom surface of both the sensor and the lead frame.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. An optical finger navigation package comprising:
a lead frame having a top and a bottom surface;
a light sensor having a first and a second surface;
a mold compound encapsulating the light sensor and the lead frame together so as to form the package; wherein the mold compound comprises a front and a back surface and at least one side surface;
a light guide system disposed on the front surface of the mold compound adjacent to the first surface of the sensor, and
a first light opaque material disposed on at least a portion of the front surface of the mold compound and a second light opaque material disposed on the second surface of the sensor.

2. The optical finger navigation package of claim 1, wherein the light guide system comprises a recessed region configured to direct light towards the light sensor.

3. The optical finger navigation package of claim 1, wherein the light guide system comprises a mirror-finish surface configured to direct light towards the light sensor.

4. The optical finger navigation package of claim 1, wherein the light guide system is substantially aligned with the first surface of the light sensor.

5. The optical finger navigation package of claim 1, wherein the lead frame is etched so as to enhance the interlocking strength between the mold compound and the lead frame.

6. The optical finger navigation package of claim 1, wherein the bottom surface of the lead frame is exposed to allow for further assembly.

7. The optical finger navigation package of claim 1, wherein the light sensor is electrically connected to the lead frame by wire bonding.

8. The optical finger navigation package of claim 1, wherein the light sensor is configured to float within the mold compound.

9. The optical finger navigation package of claim 1, wherein the second surface of the light sensor is covered with the second light opaque material and exposed on the back surface of the mold compound.

10. The optical finger navigation package of claim 1, further comprising a third light opaque material disposed on at least one side surface of the mold compound.

11. The optical finger navigation package of claim 1, wherein the opaque material is configured to shield the light sensor from stray light.

12. The optical finger navigation package of claim 1, wherein the package has a thickness less than or equal to 0.325 mm.

13. An ultra-thin optical finger navigation package comprising:
an etched lead frame having of a top surface and a bottom surface;
a light sensor having a first surface and a second surface;
a mold compound encapsulating the light sensor and the lead frame together so as to form the package; wherein the mold compound comprises a front and back surface and at least one side surface;
a light guide system disposed on the front surface of the mold compound adjacent to the first surface of the light sensor; and
a light opaque material disposed on at least a portion of the front surface of the mold compound, the second surface of the light sensor and the at least one side surface of the mold compound; wherein the light opaque material is configured to shield the light sensor from stray light;
wherein the light guide system is substantially aligned with the first surface of the light sensor and configured to direct light from the front surface of the mold compound toward the light sensor;
wherein the second surface of the light sensor is exposed and the light sensor is configured to float within the mold compound.

14. The optical finger navigation package of claim 13, wherein the light guide system comprises a recessed region configured to direct light towards the light sensor.

15. The optical finger navigation package of claim 13, wherein the light guide system comprises a mirror-finish surface configured to direct light towards the light sensor.

16. The optical finger navigation package of claim 13, wherein the light sensor is electrically connected to the lead frame by wire bonding.

17. The optical finger navigation package of claim 13, wherein the bottom surface of the lead frame is exposed to allow for further assembly.

18. The optical finger navigation package of claim 13, wherein the package has a thickness less than or equal to 0.325 mm.

19. An ultra-thin optical finger navigation package comprising:
a lead frame;
a light sensor;
a mold compound encapsulating the light sensor and the lead frame together so as to form the package, wherein the light sensor is configured to float within the mold compound;
a light guide system disposed on the mold compound; and
at least one light opaque material disposed on at least a portion of the mold compound, wherein the light opaque material is configured to shield the light sensor from stray light;
wherein the light guide system is substantially aligned with the light sensor and configured to direct light through the mold compound toward the light sensor;

20. The optical finger navigation package of claim 19, wherein the package has a thickness less than or equal to 0.325 mm.
